(19) United States
(12) Patent Application Publication
(10) Pub. No.: US 2006/0244359 A1
(43) Pub. Date: Nov. 2, 2006

(54) Compact-type discharge lamp

(76) Inventor: Seong-Jin Kang, Chungcheongnam-do (KR)

Correspondence Address: KNOBBE MARTENS OLSON & BEAR LLP, 2040 MAIN STREET, FOURTEENTH FLOOR, IRVINE, CA, 92614, US

(21) Appl. No.: 10/533,352

(22) PCT Filed: Sep. 9, 2003
(86) PCT No.: PCT/KR03/01862

§ 371 Date: Jun. 26, 2006

(30) Foreign Application Priority Data
Sep. 11, 2003 (KR) 10-2002-0054903

(51) Int. Cl. H01J 1/62

(52) U.S. Cl. 313/493

(57) ABSTRACT

The present invention provides a compact-type discharge lamp which can be used in a socket for an incandescent lamp, wherein the compact-type discharge lamp includes a discharge tube which is detachably inserted into a receptacle formed on a ballast housing.

### TECHNICAL FIELD

The present invention relates to a discharge lamp, and more particularly to a compact-type discharge lamp, wherein a ballast housing, which contains a ballast for driving the discharge lamp, and a base member are integrally formed.

A discharge lamp is widely used for lighting equipment. Generally, a discharge lamp includes a discharge tube of transparency formed of a transparent material such as glass or quartz and a ballast for driving the discharge lamp. Discharge gases such as mercury vapor and a buffer gas are inserted into the discharge tube to cause a discharge of electricity and the discharge tube is sealed. When the discharge tube is supplied with electricity from the outside by the ballast, a discharge of electricity occurs by the discharge gas inside the discharge tube, and then plasma is generated so that ultraviolet rays, visible rays or the like are emitted. A fluorescent lamp, a kind of the discharge lamp, wherein a fluorescent material is applied on the inside of its discharge tube, emits visible rays outside by being stimulated by the ultraviolet rays emitted from the plasma.

### BACKGROUND ART

Various kinds of discharge lamps have been proposed so far, and particularly, the so-called light-bulb-type discharge lamp capable of being inserted into the so-called “socket for a light bulb” has been widely used recently. In the general light-bulb-type discharge lamp, a ballast is contained in a housing of a peaked hat in shape, a base member is joined with the peaked part to be inserted into a socket for a light bulb, and other side of the ballast housing fixes and holds the discharge tube, while coupling it electrically to supply electricity.

However, in the general light-bulb-type discharge lamp, since the discharge tube, the ballast housing of a peaked hat in shape and the base member are joined in a line so that its length becomes considerably long in comparison to a general metallic-filament bulb, it has a defect that it cannot be used for light equipment for a general metallic-filament bulb.

As an attempt to solve the problem, in U.S. Pat. No. 5,541,477, a light-bulb-type discharge lamp as shown in FIG. 1 is proposed. According to U.S. Pat. No. 5,541,477, it is disclosed as follows: a compact arc lamp utilizable as an incandescent retrofit replacement with enhanced output and comprising in combination: (a) means defining an array of four elongated U-form lamp arc tubes arranged vertically with their U bases at their tops, (b) means defining a screw-in base structure with a lower screw-in base part and an upper plate mounting the lamp tubes in an enclosing array around an elongated central space, (c) means defining an electronic ballast circuit with multiple corn passive and active solid state electronics circuit ponents, mounted on a printed circuit board arranged in said central space and extending axially in the elongated central space, (d) means defining an elongated ballast housing surrounding said circuit board and within the arc tube array and extending axially with said board and tube array and constructed and arranged: (1) to support a cooling effect convective flow therein for escape of heat from the electronic ballast; and (2) to reflect heat and light from the arc tubes to limit heat penetration of the central space.

However, since the discharge lamp in accordance to U.S. Pat. No. 5,541,477 adopts a structure, in which the discharge tube and the ballast housing are joined in the screw-in base structure commonly, has a problem that the entire discharge lamp has to be disposed in case either of the discharge tube or the ballast housing has a defect.

Further, as described above, the discharge tube and the ballast housing are assembled to the screw-in base structure mechanically, and thus the heat is transferred from the discharge tube to the inside of the ballast housing through the screw-in base structure. Accordingly, the temperature inside the ballast housing increases up to an extremely high level due to the heat transfer, and consequently there's a problem that circuit elements included in the ballast become deteriorated.

### DISCLOSURE OF INVENTION

In order to solve the problems above, it is an object of the present invention to provide a discharge lamp with a discharge tube detachable, wherein a part at which a discharge tube and a ballast are mechanically coupled is minimized so that the heat transfer between the discharge tube and the ballast can be minimized.

In addition, it is another object of the present invention to provide a discharge lamp with a discharge tube detachable, wherein the discharge tube is detached when the discharge tube or the ballast has a defect so that the discharge tube or the ballast can be replaced.

In order to achieve the objects above, a compact-type discharge lamp used being inserted into a socket for a light bulb, includes a discharge tube formed of a transparent material with a space in a center thereof, comprising an electrode for supplying with electricity; a ballast housing formed to be inserted into the space of the discharge tube for containing a ballast to supply U I-Telectricity to the discharge tube and initiate and continue a discharge of electricity, comprising a coupling member mechanically joined to and electrically coupled to the electrode of the discharge tube; and a base member coupled to an end of the ballast housing to supply electricity to the ballast contained in the ballast housing.

### BRIEF DESCRIPTION OF DRAWINGS

FIG. 1 shows a general discharge lamp including a discharge tube and a ballast schematically.

FIG. 2 shows a compact-type discharge lamp according to an exemplary embodiment of the present invention schematically.

FIG. 3a is a perspective view of an exemplary embodiment of a ballast housing included in a discharge lamp in FIG. 2.

FIG. 3b is a front view of an exemplary embodiment of a ballast housing included in a discharge lamp in FIG. 2.

FIG. 3c is a plan view of an exemplary embodiment of a ballast housing included in a discharge lamp in FIG. 2.

FIG. 4 shows a state schematically in which electrodes of a discharge tube and coupling members of a ballast housing, which are included in a discharge lamp in FIG. 2, are coupled with each other.

FIG. 5 shows a discharge tube of a compact-type discharge lamp according to another exemplary embodiment of the present invention schematically.

FIG. 6a is a perspective view of an exemplary embodiment of a ballast housing capable of being joined to a discharge tube in FIG. 5.

FIG. 6b is a front view of an exemplary embodiment of a ballast housing capable of being joined to a discharge lamp in FIG. 5.

FIG. 6c is a plan view of an exemplary embodiment of a ballast housing capable of being joined to a discharge lamp in FIG. 5.

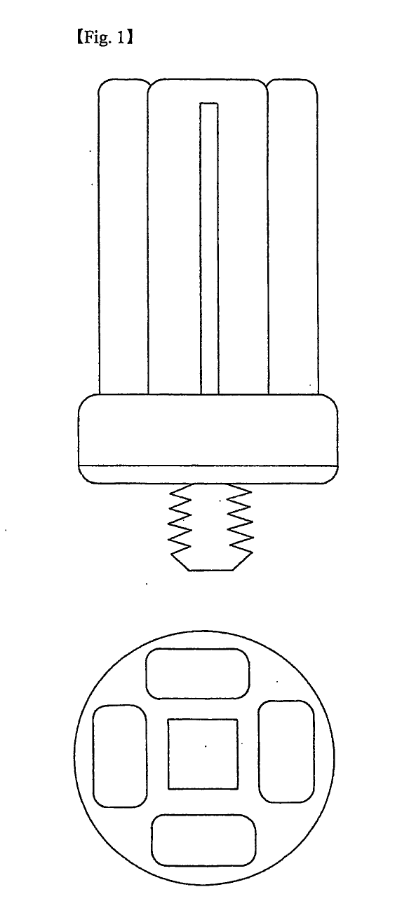

### BEST MODE FOR CARRYING OUT THE INVENTION

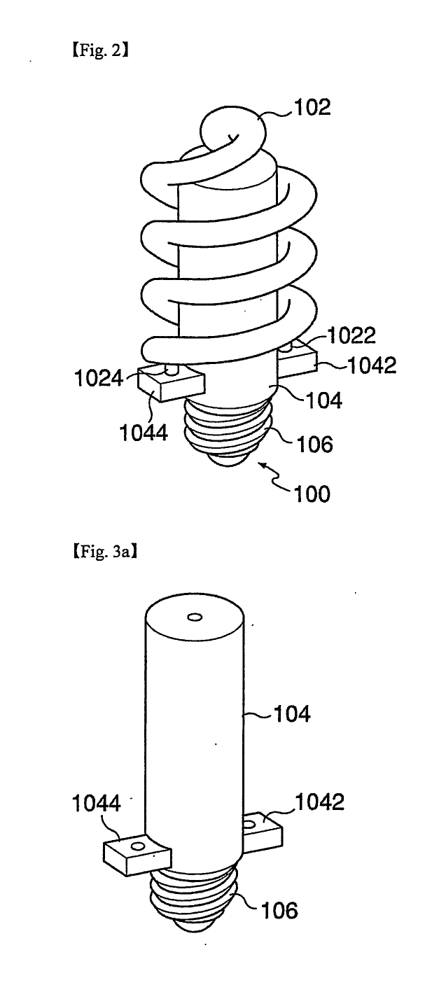

Hereinafter, exemplary embodiments of the present invention will now be described in detail with reference to attached drawings. First, with reference to FIG. 2, FIG. 2 shows a compact-type discharge lamp according to an exemplary embodiment of the present invention schematically. As shown in FIG. 2, a discharge lamp 100 according to the present embodiment includes a discharge tube 102 formed of a transparent material such as glass, quartz or the like with a space in its center, including electrodes 1022 and 1024 for electricity supply, a ballast housing 104 formed to be inserted into the space of the discharge tube, for containing a ballast to supply electricity to the discharge tube 102 and initiate and continue a discharge of electricity, including coupling members 1042 and 1044 coupled to the electrodes 1022 and 1024 of the discharge tube 102, and a base member 106 coupled to a first end of the ballast housing 104 to supply electricity to the ballast contained in the ballast housing 104.

In the discharge lamp 100 of the present embodiment, the discharge tube 102 is formed to be spiral in shape as a whole and to have the space into which the ballast housing 104 is inserted in its center. Accordingly, the entire size of the discharge lamp 100 of the present embodiment is determined mainly based on the sizes of the discharge tube 102 and the base member 106. Consequently, the size of the discharge lamp 100 of the present embodiment is extremely small in comparison to a general light-bulb-type discharge lamp 100. However, as described below, the discharge tube 102 is not necessarily to be spiral in shape. It should be noted that any structure of discharge tube may be applied to the present invention only if it has a space therein into which the ballast housing 104 can be arranged.

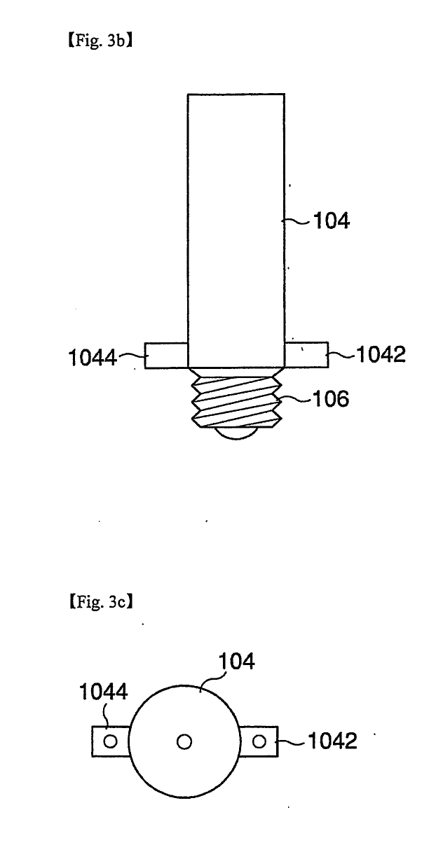

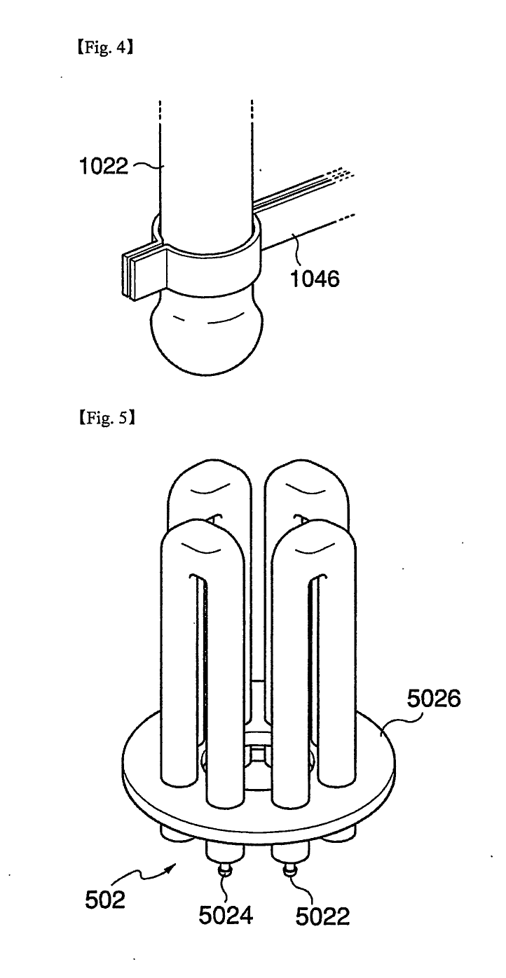

The discharge tube 102 includes the electrodes 1022 and 1024 for electricity supply from the ballast (not shown) contained in the ballast housing 104. It is preferable that the electrodes 1022 and 1024 of the discharge tube 102 are not only coupled to the coupling members 1042 and 1044 (cf. FIG. 3a to 3c and FIG. 4) formed in the ballast housing 104 electrically, but are also joined mechanically. Due to the mechanical join of the electrodes 1022 and 1024 and the coupling members 1042 and 1044, the discharge tube 102 and the ballast housing 104 can be joined mechanically. According to this structure, a region at which the discharge tube 102 and the ballast housing 104 are in contact with each other is limited only to the electrodes 1022 and 1024 and the coupling members 1042 and 1044. Accordingly, the path through which the heat occurring from the discharge tube 102 may transfer to the ballast housing 104 is limited only to the electrodes 1022 and 1024 and the coupling members 1042 and 1044, and thus only a little bit of the heat is transferred from the discharge tube 102 to the ballast housing 104. Consequently, the heat transferred to the ballast (not shown) contained in the ballast housing 104 becomes lesser. Therefore, it is possible to solve the problem of the malfunction or breakdown of the general discharge lamp caused by a high temperature.

According to another exemplary embodiment of the present invention, the discharge tube 102 and the ballast housing 104 may be separated by detaching the electrodes 1022 and 1024 from the coupling members 1042 and 1044. Due to this simple detaching-joining structure, it is possible to reuse the whole discharge lamp 100 by replacing the defected part without replacing the entire discharge lamp 100, when either the discharge tube 102 or the ballast (not shown) has a defect. Accordingly, it is possible to not only reduce the cost of the user but also to save entire resources. The structure of the coupling members 1042 and 1044 of the ballast housing 104 described above will be described below with reference to FIG. 3a and 3c.

It is preferable that the electrodes 1022 and 1024 are arranged at the lowest part of the discharge tube 102. In addition, it is also preferable that the coupling members 1042 and 1044 are arranged at the lowest part of the ballast housing 104. Due to this arrangement, it is possible to minimize the size of the entire discharge lamp 100 when the discharge tube 102 and the ballast housing 104 are joined each other.

Like a general way, inert gases such as argon, krypton along with mercury vapor are filled in the discharge tube 102. In some practical cases, amalgam, an alloy of mercury and other metal, may be contained in the discharge tube. Although an inner wall of the discharge tube 102 is preferably covered with a protecting layer such as alumina and/or a fluorescent material, it is not necessarily limited to this.

Next, the discharge lamp 100 the ballast housing 104 according to the present invention will be described in detail with reference to FIG. 3a to 3c. First, FIG. 3a is a perspective view of an exemplary embodiment of a ballast housing included in a discharge lamp in FIG. 2. As shown in FIG. 3a, the ballast housing 104 is formed of a non-conductive material to be inserted into the space formed in the center of the discharge tube 102. In the present embodiment, the ballast housing 104 is a cylindrical shape.

In addition, the ballast housing 104 is formed to be contained into the ballast (not shown) for supplying electricity to the discharge tube 102 and driving it. Moreover, the ballast housing 104 includes the coupling members 1042 and 1044 coupled to the electrodes 1022 and 1024 of the discharge tube 102 on its circumference. In addition, an outer surface of the ballast housing 104 is preferably coated with a material such as silver nitrate, aluminum, nickel or the like in order to reflect radiant light or radiant heat from the discharge tube 102.

In addition, a hole (cf. FIG. 3c) may be formed on an upper part or other proper part of the ballast housing 104 to help the heat by convection emitted, but it is not necessary to form the hole.

The coupling members 1042 and 1044 is arranged at a position corresponding to the electrodes 1022 and 1024 of the discharge tube 102 on the circumference of the ballast housing 104. As shown in the drawing, it is preferable that the coupling members 1042 and 1044 are formed to contain the electrodes 1022 and 1024 of the discharge tube 102 entirely. Since the electrodes 1022 and 1024 are contained in the coupling members 1042 and 1044 completely, it is possible to prevent accidents such as a user receives an electric shock by touching the electrodes.

Here, the coupling members 1042 and 1044 from which the discharge tube is detachable easily will be described with reference to FIG. 4. FIG. 4 schematically shows a state in which a first electrode 1022 of the discharge tube 102 and a first coupling member 1042 of the ballast housing 104, which are included in the discharge lamp in FIG. 2, are coupled with each other. That is, a terminal 1046 coupled to the ballast (not shown) is provided in the coupling member 1042. As shown in FIG. 4, the electrode 1046 is accomplished through a pair of elastic electrodes. In this case, as the electrode 1022 of the discharge tube 102 is inserted between the elastic electrodes of the terminal 1046, they can be closely coupled electrically and mechanically. Moreover, when the discharge tube 102 is pulled toward a direction opposite to the insertion direction, the electrode 1022 is separated while the elastic electrodes of the terminal 1046 are elastically widened, so that the discharge tube 102 can be detached from the ballast housing 104. The description with reference to FIG. 4 is surely applied to a second coupling member 1044 of the ballast housing 104 and a second electrode 1024 of the discharge tube 102.

The coupling member 1042 or 1044 is not limited to the structure described above. For example, the pair of elastic electrodes may be replaced with elastic projections. It should be noted that the specific configurations of the coupling member 1042 or 1044 shown and described herein are illustrative of the present invention and the inventor's conception of the best mode and are not intended to otherwise limit the scope of the present invention in any way.

Next, with reference to FIG. 3b and 3c, FIG. 3b is a front view of an exemplary embodiment of the ballast housing included in a discharge lamp in FIG. 2, and FIG. 3c is a plan view of an exemplary embodiment of the ballast housing included in a discharge lamp in FIG. 2. As shown in the drawings, the coupling members 1042 and 1044 are formed at the lower outside of the ballast housing 104 to respond to the terminals 1022 and 1024 of the discharge tube 102.

Further, as shown in the drawings, an end of the ballast housing 104 is joined to the base member 106 to be inserted into a socket for a light bulb and supplied with electricity. The ballast contained in the ballast housing 104 is supplied with electricity from the base member 106. The base member 106 may be realized through a screw-type base, so-called “Edison base” as shown in the drawings, however, it is not limited to this. For example, the base member 106 may be configured to be a Bi-pin cap of which two electrode pins protrude downwardly, and in this case the socket for a light bulb may be configured to be a socket into which the electrode pins of the Bi-pin cap are inserted.

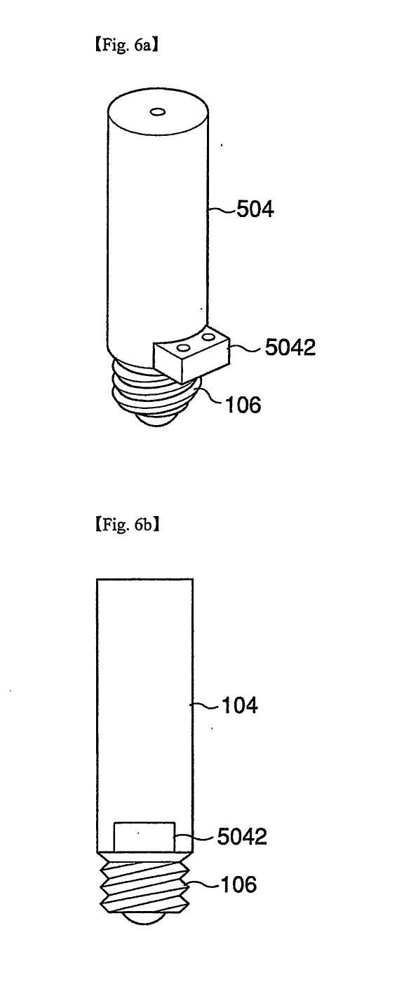

Next, another exemplary embodiment of the present invention will be described in detail with reference to FIG. 5. FIG. 5 schematically shows a discharge tube 502 of a compact-type discharge lamp according to another exemplary embodiment of the present invention. As shown in FIG. 5, in the discharge lamp according to the present embodiment, a discharge tube 502 having a space in its center by combining a plurality of u-shaped tubes in place of the spiral discharge tube 102. As shown in FIG. 5, as the u-shaped tubes are combined circularly, a space into which the ballast housing can be inserted is formed. In addition, the u-shaped tubes may be held more firmly by a tube holder 5026 surrounding the u-shaped tubes.

Since each of the u-shaped tubes is combined one another through the coupling member, electricity is supplied to the electrode 5022 and 5024 installed in one of the u-shaped tubes, and plasma can be formed in all of the u-shaped tubes constituting the discharge tube 502. Accordingly, it is possible to increase the amount of light emitted per unit size in comparison to a case of using one discharge tube.

The discharge tube 502 according to the present embodiment includes the electrode 5022 and 5024 at a predetermined position of its lower part to be supplied with electricity from the ballast (not shown).

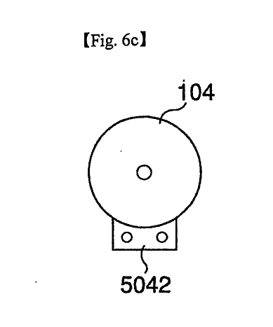

Next, with reference to FIG. 6a to 6b, FIG. 6a is a perspective view of an exemplary embodiment of a ballast housing 504 capable of being joined to the discharge tube in FIG. 5, FIG. 6b is a front view of an exemplary embodiment of a ballast housing capable of being joined to a discharge lamp in FIG. 5 and FIG. 6c is a plan view of an exemplary embodiment of a ballast housing capable of being joined to a discharge lamp in FIG. 5.

As shown in drawings, the ballast housing 504 according to the present embodiment is basically similar to the ballast housing 104 described above with reference to FIG. 3a to 3c. However, it is different in that one coupling member 5042 of the ballast housing 504 according to the present embodiment is formed to accept both of electrodes 5022 and 5024 of the discharge tube 502. In other words, the coupling member 5042 is formed to accept both electrodes 5022 and 5024 corresponding to the positions of the electrodes 5022 and 5024 of the discharge tube 502. In the coupling member 5042 according to the present embodiment, a terminal realized through a pair of elastic electrodes (not shown) described above with reference to FIG. 4 may be formed. In this case, it may be formed that the discharge tube 502 is detachable easily as well.

In addition, an end of the ballast housing 504 according to the present embodiment may be joined to the base member 106 to be mounted into a socket for a light bulb as a whole. In the foregoing specification, the invention has been described with reference to specific embodiments. However, it will be appreciated that various modifications and changes can be made without departing from the scope of the present invention as set forth in the claims below. For example, a discharge tube holder (not shown) may be added to a predetermined part of the ballast housing in order to improve a mechanically joining force of the ballast housing and the discharge tube.

### INDUSTRIAL APPLICABILITY

According to present invention, it is possible to provide a compact-type discharge lamp with a discharge tube detachable, wherein a part at which a discharge tube and a ballast are mechanically coupled is minimized so that the heat transfer between the discharge tube and the ballast can be minimized.

In addition, according to present invention, it is possible to provide a compact-type discharge lamp with a discharge tube detachable, wherein a discharge tube or a ballast can be replaced individually.

1. A compact-type discharge lamp used being inserted into a socket for a light bulb, comprising:
a discharge tube formed of a transparent material with a space in a center thereof, comprising an electrode for supplying with electricity;
a ballast housing formed to be inserted into said space of said discharge tube for containing a ballast to supply electricity to said discharge tube and initiate and continue a discharge of electricity, comprising a coupling member mechanically joined to and electrically coupled to said electrode of said discharge tube; and
a base member coupled to an end of said ballast housing to supply electricity to said ballast contained in said ballast housing.

2. A compact-type discharge lamp as claimed in claim 1, wherein said discharge tube of a spiral shape is formed in a center thereof to have a space into which said ballast housing is inserted.

3. A compact-type discharge lamp as claimed in claim 1, wherein said discharge tube is formed by combining a plurality of U-shape tubes to have said space in said center thereof.

4. A compact-type discharge lamp as claimed in claim 3 further comprising a tube holder for surrounding said U-shape tubes to hold said U-shape tubes.

5. A compact-type discharge lamp as claimed in claim 1, wherein said electrode is provided at a lowest part of said discharge tube.

6. A compact-type discharge lamp as claimed in claim 1, wherein said coupling member is provided at a lower part of said ballast housing.

7. A compact-type discharge lamp as claimed in claim 1, wherein said coupling member is provided at a position of circumference of said ballast housing to correspond to said electrode of said discharge tube.

8. A compact-type discharge lamp as claimed in claim 1 further comprising a terminal, which is coupled to said ballast, in said coupling member.

9. A compact-type discharge lamp as claimed in claim 8, wherein said terminal is a pair of elastic electrodes.

10. A compact-type discharge lamp as claimed in claim 1, wherein said discharge tube is detached from said ballast housing by separating said electrode of said discharge tube from said coupling member of said ballast housing.
